(19) United States
(12) Patent Application Publication
(10) Pub. No.: US 2025/0347773 A1
(43) Pub. Date: Nov. 13, 2025

(54) METHOD AND DEVICE FOR EVALUATING RADAR DATA FROM A RADAR SENSOR

(71) Applicant: Robert Bosch GmbH, Stuttgart (DE)

(72) Inventors: Benedikt Loesch, Stuttgart (DE); Carsten Naber, Gerlingen (DE); Daniel Schindler, Korntal-Münchingen (DE); Tobias Schmid, Fluorn-Winzeln (DE)

(21) Appl. No.: 19/096,805

(22) Filed: Apr. 1, 2025

(30) Foreign Application Priority Data
May 7, 2024 (DE) 10 2024 204 267.6

(51) Int. Cl. G01S 7/40

(52) U.S. Cl. CPC G01S 7/40

(57) ABSTRACT

A method for evaluating radar data from a radar sensor. In the method, the radar sensor generates respective radar data in a plurality of measurement cycles. The radar data are subdivided and assigned to parameter ranges of a radar spectrum. The radar data assigned to a parameter range of the radar spectrum are stored for a number of measurement cycles which depends on the parameter range. For each parameter range, the radar data assigned to the parameter range are evaluated.

### CROSS REFERENCE

The present application claims the benefit under 35 U.S.C. § 119 of German Patent Application No. 10 2024 204 267.6 filed on May 7, 2024, which is expressly incorporated herein by reference in its entirety.

### FIELD

The present invention relates to a method and a device for evaluating radar data from a radar sensor.

### BACKGROUND INFORMATION

Various methods are available for modulating radar signals. The modulated radar signals are emitted, reflected by objects and the reflected radar signals are received again in order to ascertain the distances, relative velocities and/or angular positions of the objects.

One conventional modulation method is what is the chirp sequence method, in which a package of fast frequency ramps or chirps of duration T_{f} is emitted. After this a pause T_{P} is provided. A package of chirps followed by a pause corresponds to a measurement cycle of the duration T_{f}+T_{P}.

An alternative method for radar modulation is orthogonal frequency-division multiplexing (OFDM), in which the bandwidth BW is sampled using multiple orthogonal subcarriers. The temporal sampling is carried out by emitting multiple so-called OFDM symbols.

An evaluation device for radar sensors is described in U.S. Patent Application Publication No. US 2020/0408879 A1.

### SUMMARY

The present invention provides a method and a device for evaluating radar data from a radar sensor.

Preferred example embodiments of the present invention are disclosed herein.

According to a first aspect, the present invention relates to a method for evaluating radar data from a radar sensor. According to an example embodiment of the present invention, the radar sensor generates radar data in a plurality of measurement cycles. The radar data are subdivided and assigned to parameter ranges of a radar spectrum. The radar data assigned to a parameter range of the radar spectrum are stored for a number of measurement cycles which depends on the parameter range. For each parameter range, the radar data assigned to the parameter range are evaluated.

According to a second aspect, the present invention relates to a device for evaluating radar data from a radar sensor. According to an example embodiment of the present invention, the device comprises an interface which receives radar data generated by the radar sensor in a plurality of measurement cycles. A computing device subdivides the radar data and assigns these subdivided radar data to parameter ranges of a radar spectrum. The radar data assigned to a parameter range of the radar spectrum are stored in a memory for a number of measurement cycles that depends on the parameter range. For each parameter range, the computing device evaluates the radar data assigned to the parameter range.

In radar measurements, the resolution in the distance (Δd) depends on the bandwidth BW used. The resolution in the relative velocity (Δv) depends on the measurement duration T_{f}:

$$Δ d = \frac{c}{2 B W} , Δ v = \frac{c}{2 {f}_{0} {T}_{f}} .$$

Here, c denotes the speed of light and ƒ₀ the center frequency of the radar modulation. For an unambiguous distance measurement without subsampling up to the maximum distance or range, dₘₐₓ, in the case of equidistant sampling

$$N = {d}_{m ax} / Δ d$$

sample values must be distributed across the bandwidth BW. For an unambiguous measurement of the relative velocity across a relevant relative velocity interval [vₘᵢₙ, vₘₐₓ], in the case of equidistant sampling

$$M = ( {v}_{m ax} - {v}_{m i n} ) / Δ v$$

temporal sample values must be distributed across the measurement duration T_{f}.

The maximum measurement duration T_{f} in a single package may be limited, for example due to requirements with regard to the maximum unambiguously measurable relative velocity, the maximum permissible latency up until radar localizations are output, or with regard to thermal aspects.

By jointly evaluating radar data from multiple measurement cycles (e.g., multiple chirp packages), the effective measurement duration can be significantly increased, so that the signal-to-noise ratio and the resolution in the relative velocity are significantly improved compared to the single measurement cycle.

For the joint evaluation of multiple measurement cycles, the radar data from all measurement cycles must be kept together in the memory of the radar sensor or, when the data are processed in a central control unit, they must be transmitted, which places certain demands on the transmission velocity and the digital memory.

The method according to the present invention reduces the memory requirements for cross-cycle evaluation. For this purpose, the radar data for each parameter range are stored for a prespecified number of measurement cycles. For example, the data assigned to a first parameter range can be stored for longer than the radar data assigned to a second parameter range. The radar data assigned to the second parameter range can thus be deleted earlier, thereby reducing the memory requirements.

The present invention thus ultimately proposes a targeted storage of radar data that depends on the parameter range of the radar spectrum.

For example, according to an example embodiment of the present invention, the memory can be partitioned in such a way that the performance advantage is maintained for the relevant application cases and at the same time the amount of data used for calculations for cross-cycle evaluation is significantly reduced. For example, radar data (radar frames) can only be stored for ranges of the radar spectrum (or radar image) where cross-cycle evaluation brings advantages for relevant application cases. These radar data are then stored in the memory and evaluated across measurement cycles. In this way, the amount of storage required can be massively reduced.

According to a further embodiment of the present invention of the method for evaluating radar data from the radar sensor, the radar data for each parameter range of the radar spectrum are stored in a first-in-first-out, FIFO, memory. Here the memory depth depends on the parameter range.

According to a further embodiment of the present invention of the method for evaluating radar data from the radar sensor, the parameters of the parameter range comprise at least one of a distance, a relative velocity, an azimuth angle and an elevation angle. Each parameter is then assigned a corresponding value in the radar spectrum, such as a scattering cross-section or an amplitude.

According to a further embodiment of the present invention of the method for evaluating radar data from the radar sensor, the radar data assigned to a first distance range are stored for a greater number of measurement cycles than the radar data assigned to a second distance range. The second distance range is closer to the radar sensor than is the first distance range. Latency may occur in the evaluation across measurement cycles, but this is less significant for distance ranges that are further away, and so more measurement cycles can be taken into account there.

According to a further embodiment o the present invention of the method for evaluating radar data from the radar sensor, the radar data assigned to a first angular range located centrally in front of the radar sensor are stored for a greater number of measurement cycles than are the radar data assigned to a lateral second angular range. The central angular range is usually particularly important.

According to a further embodiment of the present invention of the method for evaluating radar data from the radar sensor, partial information from the assigned radar data is selected and stored for at least one parameter range. For example, certain parameter ranges can be defined in which, statistically or through feedback from the environment detection, targets typically lie that are not recognizable in an evaluation based only on the current measurement cycle but can be recognized in an evaluation across measurement cycles. This ensures that, if at all possible, all targets that can only be detected by evaluation across measurement cycles will be present in the stored radar data.

The division of the parameter ranges can be based on statistical probabilities of targets appearing, e.g., subdivided into distance and velocity or into angle. The division of the parameter ranges can also be based on a fixed relationship between the detected targets, for example based on the number of detected targets per distance range. The division of the parameter ranges can also be based on the limitations imposed by transmission velocity and/or available memory. Another possibility for dividing the parameter ranges is to take into account feedback from the environment recognition, e.g., via scene recognition.

According to a further embodiment of the present invention of the method for evaluating radar data from the radar sensor, the partial information from the radar data is selected on the basis of a ratio of a signal power to a constant false alarm rate, CFAR, threshold value.

According to a further embodiment of the present invention of the method for evaluating radar data from the radar sensor, the subdivision of the parameter range of the radar spectrum is generated dynamically. Dynamic generation can further improve storage efficiency.

According to a further embodiment of the present invention of the method for evaluating radar data from the radar sensor, the number of measurement cycles assigned to the parameter ranges is determined dynamically. This can improve storage efficiency.

According to a further embodiment of the method for evaluating radar data from the radar sensor, the subdivision of the parameter range and/or the determination of the number of measurement cycles assigned to the parameter ranges are dynamically generated on the basis of a movement of the radar sensor. In particular, an ego trajectory of the radar sensor (or of a motor vehicle in which the radar sensor is located) can be taken into account.

According to a further embodiment of the method for evaluating radar data from the radar sensor, the subdivision of the parameter range and/or the determination of the number of measurement cycles assigned to the parameter ranges are dynamically generated on the basis of an evaluation of the radar data. In particular, parameter ranges in which relevant targets have been identified can be evaluated across multiple measurement cycles, i.e., the number of measurement cycles can be increased.

According to a further embodiment of the method for evaluating radar data from the radar sensor, the evaluation of the radar data comprises combining the radar data which have been collected in the measurement cycles. This can, for example, improve resolution.

According to a further embodiment of the method of the present invention for evaluating radar data from the radar sensor, the radar sensor operates according to a chirp sequence method or an OFDM method.

Further advantages, features and details of the present invention will become apparent from the following description, in which various exemplary embodiments are described in detail with reference to the figures.

### BRIEF DESCRIPTION OF THE DRAWINGS

FIG. 1 shows a schematic block diagram of a radar sensor with a device for evaluating radar data from the radar sensor according to an example embodiment of the present invention.

FIG. 2 shows an exemplary division of a distance/velocity parameter range of a radar spectrum, according to an example embodiment of the present invention.

FIG. 3 shows a further exemplary division of a distance/velocity parameter range of a radar spectrum, according to an example embodiment of the present invention.

FIG. 4 shows a further exemplary division of a distance/velocity parameter range of a radar spectrum, according to an example embodiment of the present invention.

FIG. 5 shows an exemplary division of an azimuth angle parameter range of a radar spectrum, according to an example embodiment of the present invention.

FIG. 6 shows a schematic diagram illustrating the storage of radar data, according to an example embodiment of the present invention.

FIG. 7 shows a flow chart of a method for evaluating radar data from a radar sensor according to an example embodiment of the present invention.

In all figures, identical or functionally identical elements and devices are provided with the same reference signs. The numbering of method steps serves the purpose of clarity and is generally not intended to imply a specific chronological order. In particular, a plurality of method steps may also be carried out simultaneously.

### DETAILED DESCRIPTION OF EXAMPLE EMBODIMENTS

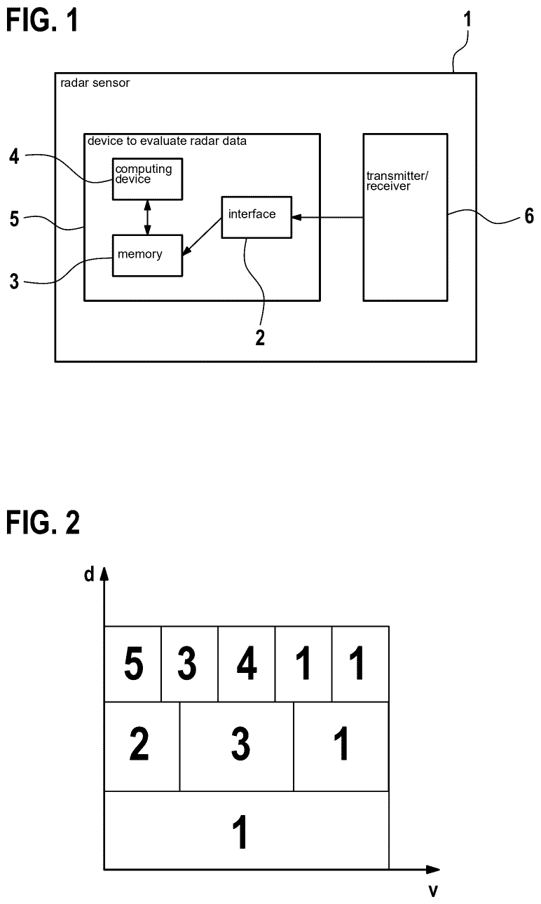

FIG. 1 shows a schematic block diagram of a radar sensor 1 with a device 5 for evaluating radar data from the radar sensor 1. The device 5 can be part of the radar sensor 1 or be external.

The device 5 comprises an interface 2 which receives radar data generated by a transmitter/receiver device 6 of the radar sensor 1 in a plurality of measurement cycles. The radar data are stored in a memory 3. A computing device 4 subdivides the radar data and assigns these divided radar data to parameter ranges of a radar spectrum.

For this purpose, the computing device 4 can first carry out radar processing of the radar data using conventional methods for determining distance and velocity, for example by forming a two-dimensional Fourier transform (Fast Fourier Transform, FFT). Optionally, an additional angle estimation can be additionally performed either on the entire radar spectrum or in individual parameter ranges, for example by beamforming or by using a deterministic maximum likelihood (DML) estimator.

The computing device 4 ascertains a radar spectrum. The parameters of the radar spectrum include, for example, a distance, a relative velocity, an azimuth angle, an elevation angle or a selection (subset) thereof.

In the memory 3, the radar data assigned to a parameter range of the radar spectrum are stored for a number of measurement cycles depending on the parameter range. For example, the radar data can be stored for each parameter range of the radar spectrum in a first-in-first-out (FIFO) memory 3.

The radar spectrum is thus divided into parameter ranges for which a different memory depth is defined, since the number of measurement cycles for which radar data are stored in a certain parameter range depends on the parameter range itself.

For each parameter range, the computing device 4 evaluates the radar data assigned to the parameter range. For each parameter range, the radar data stored across the corresponding number of measurement cycles can first be combined.

Multi-frame integration (MFI) methods can be used, such as chirp sequence 3D methods, keystone methods or back-projection methods. In this way, multiple high-resolution partial radar images can be obtained by combining the radar data from multiple measurement cycles.

The parameter range of the radar spectrum can be statically subdivided, i.e., the parameter ranges of the radar spectrum can be fixedly prespecified. For example, a static division can be made based on the requirements of typical driving situations. For example, for distant targets, an evaluation across a high number of measurement cycles is advantageous in order to improve the signal-to-noise ratio for the otherwise very faint targets and to achieve a high velocity resolution in order to be able to separate targets in the velocity that would otherwise be inseparable.

For example, a Doppler shift may occur for static objects due to the ego velocity of the radar sensor. By projecting the ego velocity V_{ego} of the radar sensor (or of a motor vehicle in which the radar sensor is located) onto a static target with the velocity

$${v}_{target} = {v}_{ego} cos {θ}_{target}$$

where θ_{target} denotes the azimuth angle of the target, only a small Doppler shift results, in particular for targets close to boresight, i.e., centrally in front of the radar sensor, which can be resolved with a higher number of combined measurement cycles.

In a further embodiment, the radar data assigned to a first velocity range may be stored for a greater number of measurement cycles than the radar data assigned to a second velocity range, wherein the first velocity range corresponds to targets moving toward the radar sensor. Such targets are typically more important than targets that are moving away from the radar sensor or vehicle (e.g., in the second velocity range), which is why an evaluation across multiple measurement cycles is advantageous for the first velocity range, while in the second velocity range the evaluation across one measurement cycle may be sufficient.

The subdivision of the parameter range of the radar spectrum can be effected dynamically. Additionally or alternatively, the number of measurement cycles assigned to the parameter ranges can be determined dynamically.

The dynamic generation of the subdivision of the parameter range and/or the determination of the number of measurement cycles assigned to the parameter ranges can be carried out on the basis of a movement of the radar sensor. For example, a division of the parameter range can be based on an ascertained ego trajectory of the radar device. Depending on the velocity and direction of travel, different areas in the distance, velocity and/or angle spectra will be of interest. For example, at high ego velocities, distant targets will be more important than at low ones.

Additionally or alternatively, the subdivision of the parameter range and/or the determination of the number of measurement cycles assigned to the parameter ranges can be dynamically generated on the basis of an evaluation of the radar data.

For example, in a downstream processing step of perception, objects can be detected and their trajectories estimated on the basis of the radar targets and possible other information sources, such as other sensors or map material. This process makes it possible to identify certain parameter ranges of the radar spectrum in which a radar measurement with a higher signal-to-noise ratio or higher Doppler resolution can lead to a better perception of the situation.

For example, the approach of the ego vehicle to a bridge can be detected, wherein in the corresponding parameter ranges of the radar spectrum the memory depth for the multi-cycle processing is increased to such an extent that the velocity resolution is improved in such a way that an early separation of the bridge from a possible tail of a traffic jam is possible.

FIG. 2 shows an exemplary division of a distance (d)/velocity (v) parameter range of a radar spectrum, with exemplary values for memory depths entered. The radar spectrum is subdivided into different parameter ranges depending on the distance d and the velocity. At least some parameter ranges are assigned greater memory depths at a greater distance, i.e., a number of measurement cycles across which radar data of the corresponding parameter range are stored, for example 4 or 5 instead of 1 to 3. However, these values are only to be understood as examples. In this example, the radar data assigned to a first distance range are thus stored for a larger number of measurement cycles than are the radar data assigned to a second distance range. The second distance range is closer to radar sensor 1 than is the first distance range.

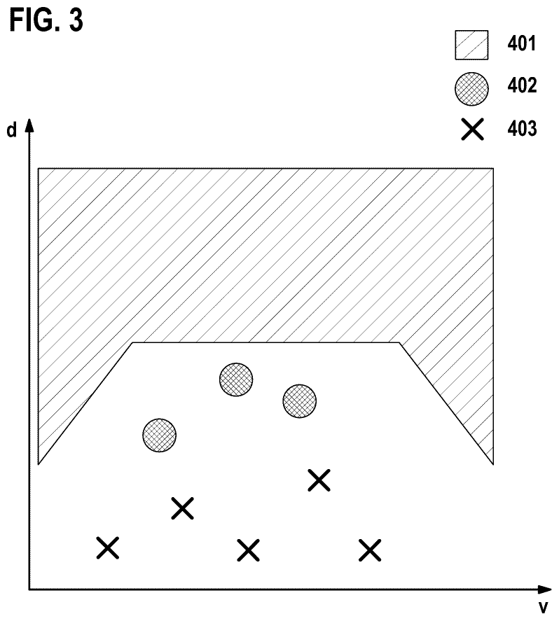

FIG. 3 shows another exemplary division of a distance/velocity parameter range (d-v diagram) of a radar spectrum. The subdivision of the distance/velocity parameter range depends on a ratio of a signal power of the radar radiation of the corresponding parameter range to a constant false alarm rate (CFAR) threshold value.

In a first parameter range 401, the signal-to-noise ratio of individual evaluations is too low for detecting a specific target, e.g., pedestrians, with sufficient probability. For example, the signal power there is lower than the CFAR threshold. However, an evaluation across measurement cycles may provide a detection, and so a large amount of data should be retained there. For this reason, all information can be transmitted and stored in the first parameter area 401 (the spectrum). This information includes, for example, a complex amplitude for each relevant transmitter/receiver antenna combination for each point within this first parameter range 401.

In a second parameter range 402 the uncertainty is lower, but possible occlusions may occur. The signal-to-noise ratio can typically already be sufficient for a single evaluation, for example if the signal power is greater than or equal to the CFAR threshold, with a small difference, e.g., less than 3 decibels. However, due to the nature of the scene or the distribution of the targets, overlapping of other targets could occur, e.g., in the direction of velocity. The radar data are therefore selected so that the amount of data can be significantly reduced.

The second parameter range 402 includes sections that are close to detected targets. There, radar data are transmitted and stored across multiple measurement cycles. The radar data can be selected, for example, the complex amplitudes can be stored for each relevant transmitter/receiver antenna combination. As a result, the increased Doppler separability may allow an additional target to be detected in the evaluation across measurement cycles that would otherwise have been masked.

To select the relevant radar data, a detection can first take place, for example with CFAR and a subsequent peak detection. Depending on this, a fixed or dynamically defined area surrounding the detection can be selected. For example, a predetermined number of pixels (e.g., 2 pixels) can be statically selected around the detection points. The number of pixels can also be dynamic, for example depending on the signal-to-noise ratio.

In a third parameter range 403, the signal-to-noise ratio of the individual enhancement is sufficient (e.g., the signal power is significantly greater than the CFAR threshold) and the probability of overlaps occurring due to the scene or distribution of the targets is almost excluded. In this case, for example, the detected target can be transmitted and stored together with the phase information (e.g., a complex-valued amplitude) for all relevant transmitter/receiver antenna combinations. Alternatively, in addition to the typical parameters of a target detection, meta-information such as a peak width can also be added.

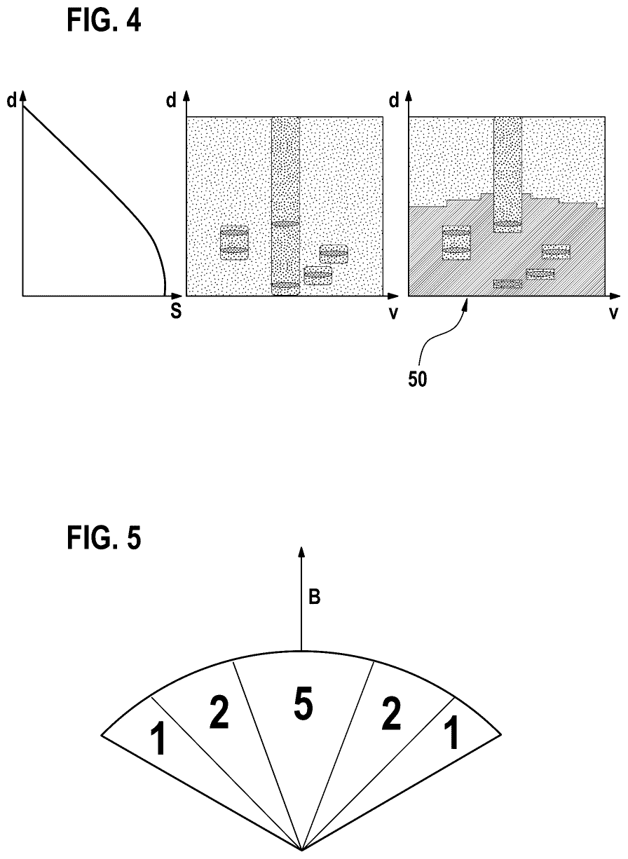

FIG. 4 shows another exemplary division of a distance/velocity parameter range of a radar spectrum. On the left, a minimum CFAR threshold S is shown as a function of the distance d. In the middle, a radar spectrum is illustrated by way of example, with distance d and relative velocity v. On the right, the radar spectrum after CFAR evaluation is illustrated, wherein in a parameter range 50 the radar data are partially or completely discarded. The CFAR threshold can more generally depend on the distance d, the relative velocity and/or an angle, or can be adjusted dynamically by feedback from the environment detection.

FIG. 5 shows an exemplary division of an azimuth angle parameter range of a radar spectrum, wherein exemplary values for memory depths are entered. Targets that are directly in front of the vehicle and therefore much more likely to be in the path of travel may be more interesting than targets in peripheral areas. Through the relationship

$${v}_{target} = {v}_{ego} cos {θ}_{target}$$

for static targets, there is also a greater difference in the projected Doppler shift for targets with a greater azimuth angle deviation, which means that a coarser Doppler separability may already be sufficient. For this reason, in this exemplary embodiment, a greater memory depth (e.g., 5) is assigned to an area directly in front of the vehicle (along a forward direction B; “boresight”) than to azimuth angle ranges further out (e.g., memory depth 1 or 2).

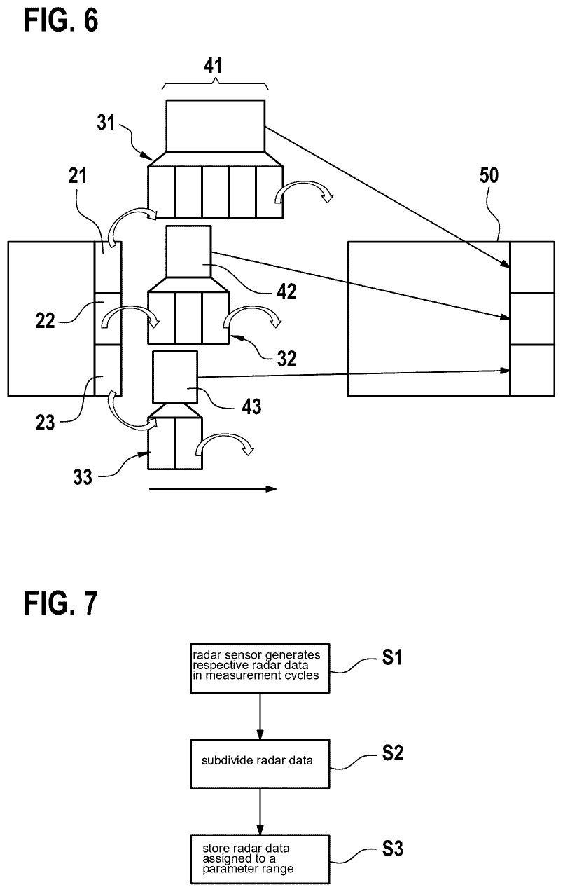

FIG. 6 shows a schematic diagram illustrating the storage and processing of partial radar images across multiple measurement cycles. Radar data are subdivided and assigned to corresponding parameter ranges, i.e., partial radar data or partial radar images 21 to 23 are generated, wherein three partial radar images 21 to 23 are shown by way of example.

The most recent partial radar image of the relevant parameter range is stored in a corresponding FIFO memory 31, 32, 33. In each case, the oldest entry, i.e., the oldest partial radar image 21, 22, 23, is discarded. The depth of the FIFO memory 31, 32, 33 depends on across how many measurement cycles the corresponding partial radar image 21, 22, 23 is calculated. After each measurement cycle, high-resolution partial radar images 41, 42, 43 are calculated, regardless of the depth. The depth of the FIFO memory 31, 32, 33 therefore only influences the latency with which a complete high-resolution partial radar image 41, 42, 43 is calculated, but not the update rate. When the high-resolution partial radar images 41, 42, 43 are generated, all partial radar images 21, 22, 23 are combined in the relevant FIFO memory 31, 32, 33 and evaluated together. Finally, a final radar image 50 is generated, into which the high-resolution partial radar images 41, 42, 43 are incorporated.

FIG. 7 shows a flowchart of a method for evaluating radar data from a radar sensor, for example the radar sensor 1 described above.

In a first step S1, the radar sensor 1 generates respective radar data in a plurality of measurement cycles.

In a step S2, the radar data are subdivided and assigned to parameter ranges of a radar spectrum.

In a step S3, the radar data assigned to a parameter range of the radar spectrum are stored for a number of measurement cycles which depends on the parameter range. The radar data can be stored for each parameter range of the radar spectrum in a first-in-first-out, FIFO, memory 3. The parameters of the parameter range can include at least one of a distance, a relative velocity, an azimuth angle and an elevation angle. The parameter range of the radar spectrum can be subdivided statically or dynamically. The number of measurement cycles assigned to the parameter ranges can also be determined statically or dynamically.

The subdivision of the parameter range and/or the determination of the number of measurement cycles assigned to the parameter ranges can be dynamically generated on the basis of a movement of the radar sensor 1, for example a trajectory.

Additionally or alternatively, the subdivision of the parameter range and/or the determination of the number of measurement cycles assigned to the parameter ranges can be dynamically generated on the basis of an evaluation of the radar data.

For each parameter range, the radar data assigned to the parameter range are evaluated. For this purpose, the radar data stored across the number of measurement cycles depending on the parameter range can first be combined.

What is claimed is:

1. A method for evaluating radar data from a radar sensor, comprising the following steps:
generating respective radar data by the radar sensor in a plurality of measurement cycles;
subdividing and assigning the radar data to respective parameter ranges of a radar spectrum, wherein the radar data assigned to each respective parameter range of the radar spectrum are stored for a number of measurement cycles depending on the respective parameter range; and
evaluating, for each parameter range, the radar data assigned to the respective parameter range.

2. The method according to claim 1, wherein the radar data for each respective parameter range of the radar spectrum are stored in a first-in-first-out (FIFO) memory.

3. The method according to claim 1, wherein parameters of the each parameter range include at least one of: a distance, a relative velocity, an azimuth angle, an elevation angle.

4. The method according to claim 1, wherein the radar data assigned to a respective parmeter range having a first distance range are stored for a greater number of measurement cycles than are the radar data assigned to a respective parameter range having a second distance range, wherein the second distance range is closer to the radar sensor than is the first distance range.

5. The method according to claim 1, wherein the radar data assigned to respective parameter range having a first angular range located centrally in front of the radar sensor are stored for a greater number of measurement cycles than are the radar data assigned to a respective parameter range having a lateral second angular range.

6. The method according to claim 1, wherein partial information from the assigned radar data is selected and stored for at least one parameter range.

7. The method according to claim 6, wherein the partial information from the radar data is selected based on a ratio of a signal power to a constant false alarm rate (CFAR) threshold value.

8. The method according to claim 1, wherein the subdivision of the parameter range of the radar spectrum and/or the number of measurement cycles assigned to the parameter ranges are generated dynamically.

9. The method according to claim 8, wherein the dynamic generation takes place based on a movement of the radar sensor.

10. The method according to claim 8, wherein the dynamic generation takes place based on an evaluation of the radar data.

11. The method according to claim 1, wherein the evaluation of the radar data includes combining the radar data stored across the number of measurement cycles depending on the parameter range.

12. A device for evaluating radar data from a radar sensor, comprising:
an interface configured to receive radar data generated by the radar sensor in a plurality of measurement cycles;
a computing device configured to subdivide the radar data and assign the radar data to respective parameter ranges of a radar spectrum; and
a memory which is configured to store the radar data assigned to each respective parameter range of the radar spectrum for a number of measurement cycles depending on the respective parameter range;
wherein the computing device is further configured to evaluate the radar data assigned to the respective parameter range for each respective parameter range.
